(19) United States
(12) Patent Application Publication
(10) Pub. No.: US 2012/0031066 A1
(43) Pub. Date: Feb. 9, 2012

(54) CHOPPING CORN STALKS AND LIKE CROP RESIDUE

(75) Inventors: Blake Neudorf, Vonda (CA); Montgomerie Summach, St. Brieux (CA); Cameron Wilson, Vonda (CA)

(73) Assignee: HIGHLINE MANUFACTURING INC., St. Brieux (CA)

(21) Appl. No.: 12/913,554

(22) Filed: Oct. 27, 2010

(30) Foreign Application Priority Data
Aug. 9, 2010 (CA) 2712554

(51) Int. Cl. A01D 43/08

(52) U.S. Cl. 56/502

(57) ABSTRACT

A method of lifting corn stalks from a field surface and chopping the corn stalks with a rotary mower comprises configuring blades of the blade assembly such that as the blade assembly rotates, air is drawn upward under the mower deck; configuring the rotary mower such that an area of a circle defined by a circular path of outer tips of blades of the blade assembly is greater than 60 square feet; and rotating the blade assembly such that the outer tips of the blades move at a speed greater than 20,000 feet per minute and such that the air drawn upward under the mower deck draws corn stalks up from the field surface into contact with the blades.

This invention is in the field of agricultural field operations and in particular chopping corn stalks and like crop residue to facilitate reduced tillage and no-till field operations such as seeding.

### BACKGROUND

Reduced tillage and no-till agricultural practices, where little or no tillage of the soil takes place, significantly reduces the moisture loss from soil, and also reduces fuel and equipment costs. A major problem with reduced tillage practices is that crop residue from the previous crop is left in the field after harvest, and is not turned under by cultivation which facilitates decomposition of the residue, and also spreads out the residue.

Subsequent seeding operations typically require that furrows be opened in the soil, and undisturbed crop residue lying on the soil surface interferes with those later seeding operations. The residue typically comprises chaff and like smaller pieces of dead plant material, but also longer pieces such as straws, vines, and stalks. When the furrow openers of a seeder move through the residue, the smaller pieces flow between the furrow openers, but the longer straws and stalks hang on the furrow opener shanks and are dragged along the ground picking up further residue, increasing drag, reducing penetration of the furrow openers into the ground, and often plugging the seeder.

It is therefore known to chop the crop residue to reduce the longer pieces to smaller pieces that will flow between the furrow openers and allow a no-till seeding operation to proceed efficiently. Rotary mowers are commonly used for this purpose. Typically rotary mowers comprise a blade assembly rotatably mounted under a mower deck about a vertical axis. The deck is mounted either on wheels or directly to a towing vehicle such as a tractor. Where a wider mower is desired, one or more wing decks are pivotally attached on each side of a center deck such that the wings can flex with respect to the center deck to follow ground contours. Since modern farms are quite large, wide mowers have been developed to cover large acreages, such as are disclosed in U.S. Pat. No. 5,113,640 to Colistro and United States Patent Application 2004/0148917 of Eastwood. Wide rotary mowers are also used for applications such as mowing highway rights of way, airport borders, and like large areas of vegetation.

Rotary mowing is effective in facilitating no-till seeding operations in many types of crop residue such as the residue of a wheat crop, however the residue left after other crops, such as corn, are problematic. During harvest, a significant proportion of corn stalks pass through the harvesting equipment essentially whole, with only the cobs stripped off. These corn stalks are tough and fibrous and do not readily breakup when chopped with conventional rotary mowers. Another significant problem is that many of the stalks lie flat on the ground and the blades of the rotary mower simply pass over top of them without even contacting the stalks. Even a few un-chopped corn stalks can significantly interfere with a no-till seeding operation. Chopping residue from a corn crop with rotary mowers is thus seldom satisfactory.

### SUMMARY OF THE INVENTION

It is an object of the present invention to provide a method and apparatus for lifting corn stalks and like crop residue from a field surface and chopping the corn stalks with a rotary mower that overcomes problems in the prior art.

In a first embodiment the present invention provides a method of lifting corn stalks from a field surface and chopping the corn stalks with a rotary mower comprising a rotating blade assembly mounted under a mower deck. The method comprises configuring blades of the blade assembly such that as the blade assembly rotates, air is drawn upward under the mower deck; configuring the rotary mower such that an area of a circle defined by a circular path of outer tips of blades of the blade assembly is greater than 60 square feet; and rotating the blade assembly such that the outer tips of the blades move at a speed greater than 20,000 feet per minute and such that the air drawn upward under the mower deck draws corn stalks up from the field surface into contact with the blades.

In a second embodiment the present invention provides a rotary mower apparatus for lifting corn stalks from a field surface and chopping the corn stalks. The apparatus comprises a rotating blade assembly mounted under a mower deck, wherein blades of the blade assembly are configured such that as the blade assembly rotates, air is drawn upward under the mower deck. The area of a circle defined by a circular path of outer tips of blades of the blade assembly is greater than 60 square feet, and the blade assembly rotates at a rotational speed such that the outer tips of the blades move at a speed greater than 20,000 feet per minute and such that the air drawn upward under the mower deck draws corn stalks up from the field surface into contact with the blades.

In a third embodiment the present invention provides a rotary mower apparatus adapted for connection to a power take off shaft of a tractor. The apparatus comprises a rotating blade assembly mounted under a mower deck and rotated by a driveline connected to the power take off shaft, the blade assembly having a diameter of at least nine feet; and a mechanism operative to reduce a start-up torque required to be exerted by the tractor power take off shaft to begin rotation of the blade assembly.

Increasing the volume of air under the mower deck and the speed of the blades increases the updraft of air such that corn stalks that are left lying on the ground by prior art rotary mowers are drawn up and into the blades to be chopped. Reducing start-up torque allows a tractor to start a large diameter blade assembly without stalling.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective bottom view of an embodiment of a rotary mower apparatus of the present invention;

FIG. 2 is a schematic illustration of the blade creating an updraft of air sufficient to draw corn stalks up off the field surface;

FIG. 3 is a schematic bottom view of a blade assembly for use with the embodiment of FIG. 1;

FIG. 4 is a schematic sectional side view of an embodiment of the rotary mower apparatus that includes a mechanism operative to reduce a start-up torque required to be exerted by a tractor power take off shaft to begin rotation of the blade assembly;

FIG. 5 is a schematic bottom view of the blade assembly with coil spring bias elements of the embodiment of FIG. 4;

FIG. 6 is a schematic bottom view of an alternate blade assembly with coil spring bias elements that could also be used with the embodiment of FIG. 4;

FIG. 7 is a perspective view of an embodiment of a multiple section rotary mower of the present invention with an alternate mechanism operative to reduce a start-up torque, the mechanism comprising a centrifugal clutch;

FIG. 8 is a schematic bottom view of a mower deck of the present invention comprising a plurality of elongate retarding members mounted below the underside of the mower deck;

FIGS. 9A-9C are schematic sectional views along line 9-9 in FIG. 8 illustrating a variety of cross-sectional shapes of retarding members.

### DETAILED DESCRIPTION OF THE ILLUSTRATED EMBODIMENTS

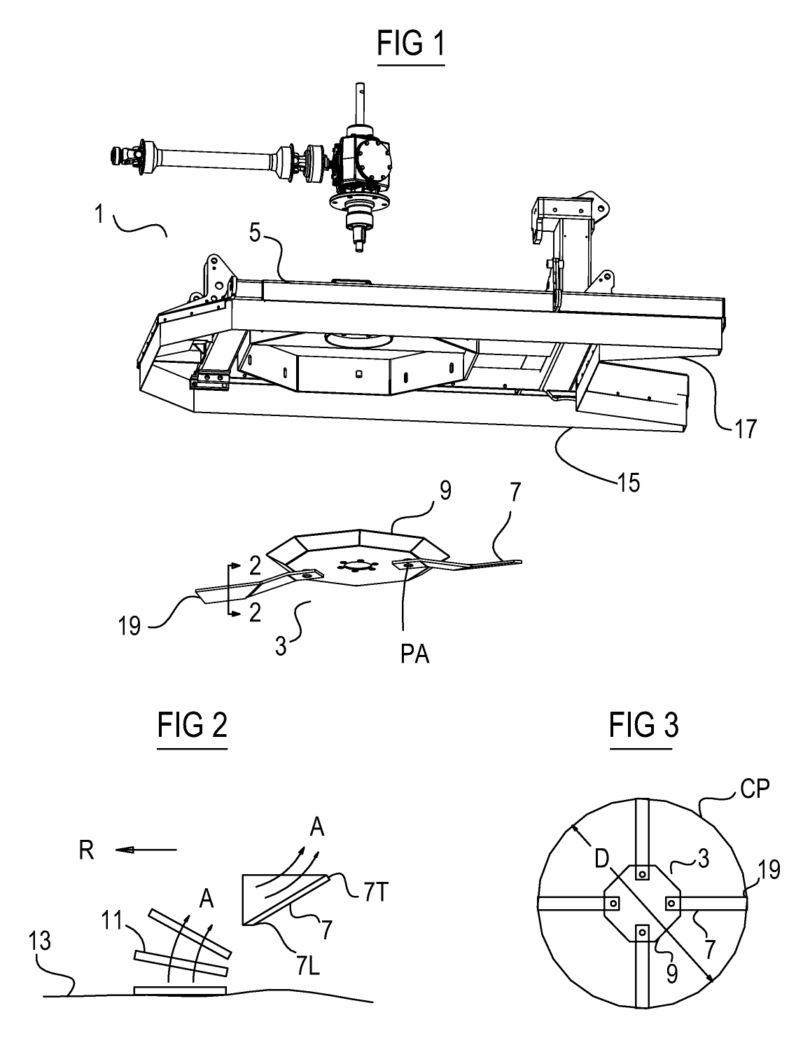

The invention provides a method of lifting corn stalks from a field surface and chopping the corn stalks with a rotary mower apparatus. As illustrated in FIG. 1, the rotary mower apparatus 1 comprises a rotating blade assembly 3 mounted under a mower deck 5. The method comprises configuring blades 7 of the blade assembly 3 such that as the blade assembly 3 rotates, air is drawn upward under the mower deck 5. In the illustrated apparatus 1, the blade assembly 3 comprises a central portion 9, and the blades 7 are pivotally attached to the central portion 9 about substantially vertical blade pivot axes PA. The blades 7 are configured such that as the blade assembly 3 rotates in direction R, the outer leading edge 7L of the blade 7 slopes upward to the outer trailing edge 7T thereof, as illustrated in FIG. 2. Thus air contacted by the blade 7 moves up the slope and draws air upward from below the blade 7 creating an updraft of air as indicated by the arrows A.

The rotary mower apparatus 1 is configured so that the amount of air drawn upward by the rotating blades 7 is much greater than in the prior art, such that the upward moving air A exerts a suction force sufficient to lift corn stalks 11 or like lengths of crop residue up from the field surface 13 and into the path of the rotating blades 7. The rotary mower apparatus 1 accomplishes this by providing a much larger area under the mower deck 5 to increase the volume of air that is being moved by the blades 7, and also by increasing the speed at which the blades 7 are moving to drive the air upward more forcefully.

The sides and front of the area under the mower deck 5 are shown as enclosed by downward extending panels 15 of flexible belting material to allow stones or the like struck by the blades to pass out from under the mower deck 5 while being slowed by the flexible panels to reduce the hazard of flying stones. The rear end 17 is also enclosed by flexible belting material which flexes to allow cut material be discharged as the mower moves forward. As is known in the art, lengths of chain could also be used instead of the belting material

The present inventors have found that the volume of moving air is sufficient where the area of the circle defined by the circular path CP of outer tips 19 of blades 7, as illustrated in FIG. 3, is greater than 60 square feet, and where the outer tips 19 of the blades 7 move at a speed greater than 20,000 feet per minute, the air drawn upward under the mower deck 5 draws at least the great majority of corn stalks 11 up from the field surface 13 into contact with the blades 7, such that a field of corn residue can be chopped sufficiently to allow a typical seeding implement to operate satisfactorily.

A blade assembly with a diameter D of at least nine feet provides a circle defined by the circular path CP with an area of over 63 square feet, while a blade assembly with a diameter of ten feet provides such a circle with an area of over 78 square feet. Since it is blade tip speed which affects the updraft of air, the ten foot blade assembly can be rotated at a slower rotational speed than the nine foot blade. To achieve a blade tip speed of 20,000 feet per minute the nine foot blade must be rotated at about 708 revolutions per minute (rpm) while the ten foot blade must only be rotated at about 637 rpm.

While it is contemplated that increasing the diameter and tip speed further would create a stronger updraft, it is also contemplated that a ten foot blade assembly with a blade tip speed of about 20,000 to 22,000 feet per minute will provide a sufficiently strong updraft for the purpose while at the same time being of a size and with an operating speed that can be practically achieved and maintained.

Conventional large rotary mowers use a blade assembly that is at most about six feet in diameter. The area of the circle defined by the circular path of the blade tips of these conventional mowers thus has an area of only slightly over 28 square feet, providing a volume of air under the mower deck that is less than half that of the rotary mower apparatus 1 of the present invention. Further, in order to achieve a blade tip speed of 20,000 feet per minute the conventional six foot blade must be rotated at 1061 rpm, much faster than present conventional rotary mowers, which typically are rotated at about 900 rpm and thus have a blade tip speed of only about 17,000 feet per second. The conventional mower thus generates a much less forceful updraft of air, with the result that a great many corn stalks are left on the field surface, hindering later seeding operations.

As well as increasing the air flow, an additional benefit is derived from increasing the blade tip speed. The increased blade speed imparts significantly increased force and energy into the stalks contacted by the blade such that the tough corn stalks shatter more and are chopped into smaller pieces than when contacted at the lower speeds.

The present inventor has found that a problem arises with the inertia of the blade assembly when using large diameter blade assemblies with a diameter of ten feet. The moment of inertia of an object about a given axis is a measure of how difficult it is to change its angular motion about that axis. It requires more effort to change the angular velocity of a body with a larger diameter because its mass is distributed farther from its axis of rotation. Mass that is farther out from that axis must, for a given angular velocity, move more quickly than mass closer in. Thus the inertia will commonly stall the engine of the tractor driving large diameter blades while a mower of the same width with a plurality of smaller diameter blades can be started easily. The start-up inertia is an especially significant problem when the rotary mower has a plurality of mower decks. It is contemplated that the rotary mower apparatus could have five blades to make a 50 foot wide cut, and so inertia at start-up will be very high.

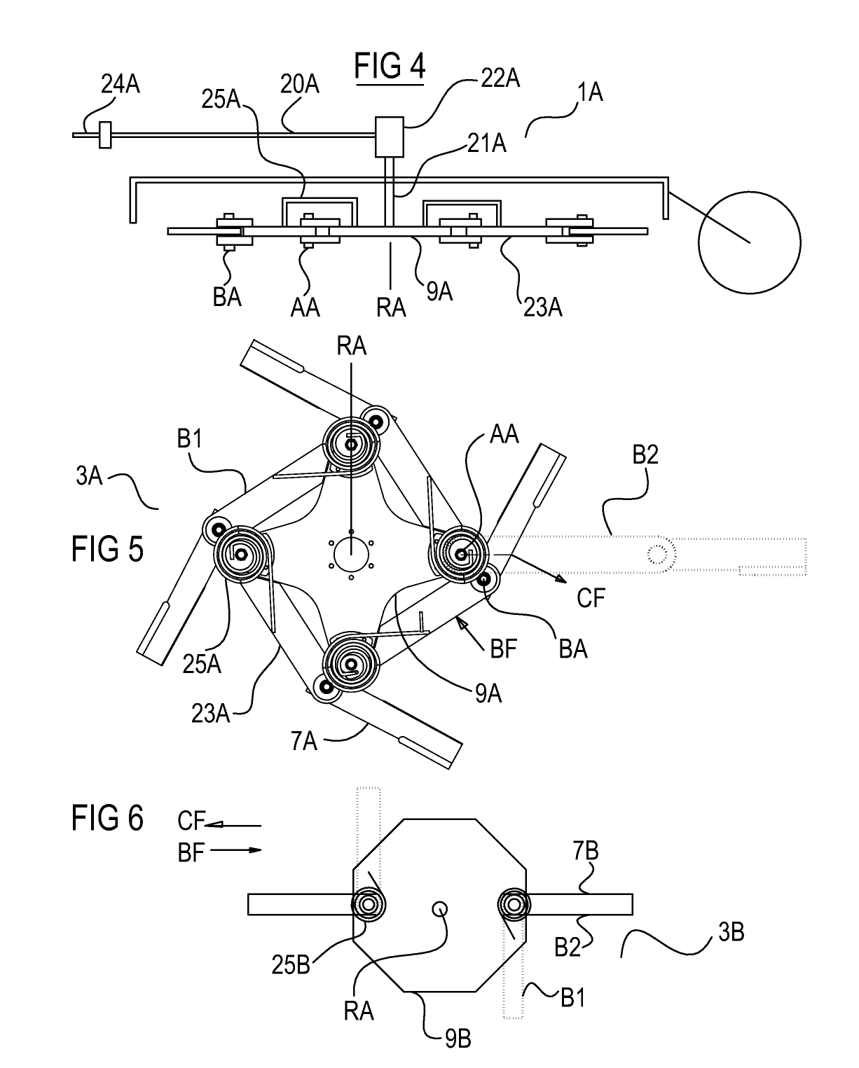

A mechanism can be provided to reduce a start-up torque required to be exerted by a tractor power take off shaft to begin rotation of the blade assembly. Such a mechanism is schematically illustrated in FIGS. 4 and 5 where a the blade assembly 3A comprises a central portion 9A attached at a rotational axis RA thereof to a substantially vertically oriented rotating drive shaft 21A of the rotary mower apparatus 1A. The drive shaft 21A is connected to a gear box 22A that is driven by a shaft 20A that is connected to the tractor power take off shaft 24A.

A plurality of blade arms 23A are each pivotally attached at inner ends thereof to the central portion 9A about a substantially vertical arm axis AA, and a blade 7A is pivotally attached to an outer portion of each blade arm 23A about a blade pivot axis BA. The arm axes AA are substantially equally spaced about the rotational axis RA to balance the blade assembly 3A. The illustrated blade assembly 3A has four blade arms 23A, each attached at 90 degrees around the rotational axis RA but it is contemplated that, depending on the application, other numbers could be used. For example three blade arms could each be attached at 120 degrees around the rotational axis RA, or two blade arms could each be attached at 180 degrees around the rotational axis RA.

It is contemplated that increasing the number of rotating blades 7A from two to three or four blades 7A will increase the volume of air moving upward and thus increase the ability of the apparatus 1A to lift corn stalks and the like up off the field surface.

A bias element is operative to exert a bias force BF on each blade arm 23A urging each blade arm 23A to pivot about the arm axis AA toward the rotational axis RA to the blade position B1, such that the mass of the blades 7A and blade arms 23A is closer to the rotational axis RA, therefore reducing the start-up inertia of the blade assembly 3A. In the illustrated apparatus 1A, the bias element is provided by a coil spring 25A mounted above blade arms 23A and central portion 9A where they are least subject to damage from contacting rocks and like debris. Each coil spring 25A is connected to the central portion 9A and a blade arm 23A, and each spring 25A is operative to exert the bias force BF on the connected blade arm 23A. The coil springs 25A, are configured such that as the drive shaft 21A rotates, centrifugal forces CF are exerted on the blade arms 23A opposite the bias force BF that are greater than the bias force BF such that the blade arms 23A, and blades 7A attached thereto, extend outward from the rotational axis RA, to the blade position B2 shown in phantom lines in FIG. 5.

FIG. 6 illustrates a simpler version of a mechanism to reduce a start-up torque. The blade assembly 3B comprises a central portion 9B rotating about a substantially vertical rotational axis RA, with blades 7B pivotally attached to the central portion 9B about substantially vertical blade pivot axes BA. A bias force BF is exerted by coil springs 25B on each blade 7B urging each blade 7B to pivot about the blade axis BA toward the rotational axis RA to the position B1, illustrated by phantom lines as above such that the mass of the blades 7B is closer to the rotational axis RA, therefore reducing the start-up inertia of the blade assembly 3B. As above centrifugal forces CF are exerted on the blades 7B opposite the bias force BF that are greater than the bias force BF such that the blades 7B extend outward from the rotational axis RA, to the blade position B2 shown.

The double folding blade arm 23A and blade 7A of FIG. 5 brings the mass of the blade assembly 3A closer to the rotational axis RA than the simpler version of FIG. 6 and thus further reduces the initial inertia of the blade assembly. It is contemplated however that in some applications the simple version may provide a sufficient inertia reduction for the purpose.

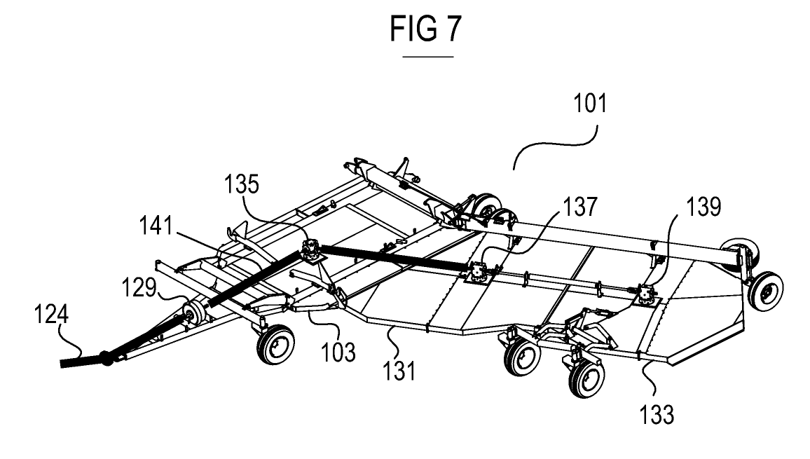

FIG. 7 schematically illustrates an alternate mechanism to reduce a start-up torque required to be exerted by a tractor power take off shaft to begin rotation of the blade assembly by providing at least one centrifugal clutch 129 in a drive line of the rotary mower apparatus 101. FIG. 7 illustrates partial view of rotary mower apparatus 101 with a center mower deck 103, and inner wing deck 131, and an outer wing deck 133 with a ten foot diameter blade assembly mounted under each deck and driven by corresponding gear boxes 135, 137, and 139. The illustrated centrifugal clutch 129 is positioned in the main drive line 141 connecting the tractor power take off shaft 124 to the first gearbox 135 but it is contemplated that a plurality of centrifugal clutches could be positioned in the drive shafts at locations farther along the drive train, such as on the final drive for each blade assembly, and provide satisfactory results as well.

When rotation of the tractor power take off shaft 124 is initiated, the input end of the centrifugal clutch 129 begins to turn and as speed builds up in the input side of the centrifugal clutch 129, the output side thereof slowly begins to turn and in turn begins to turn the first gearbox 135 and the downstream connected gear boxes 137, 139 which are connected directly to the gearbox 135 and turn when the gearbox 135 turns. Thus start-up torque exerted by the tractor power take off shaft 124 is reduced since the centrifugal clutch 129 acts to slowly start the gearboxes 135, 137, 139, and their attached blade assemblies, rotating only after the tractor power take off shaft 124 is rotating and the tractor engine is developing torque.

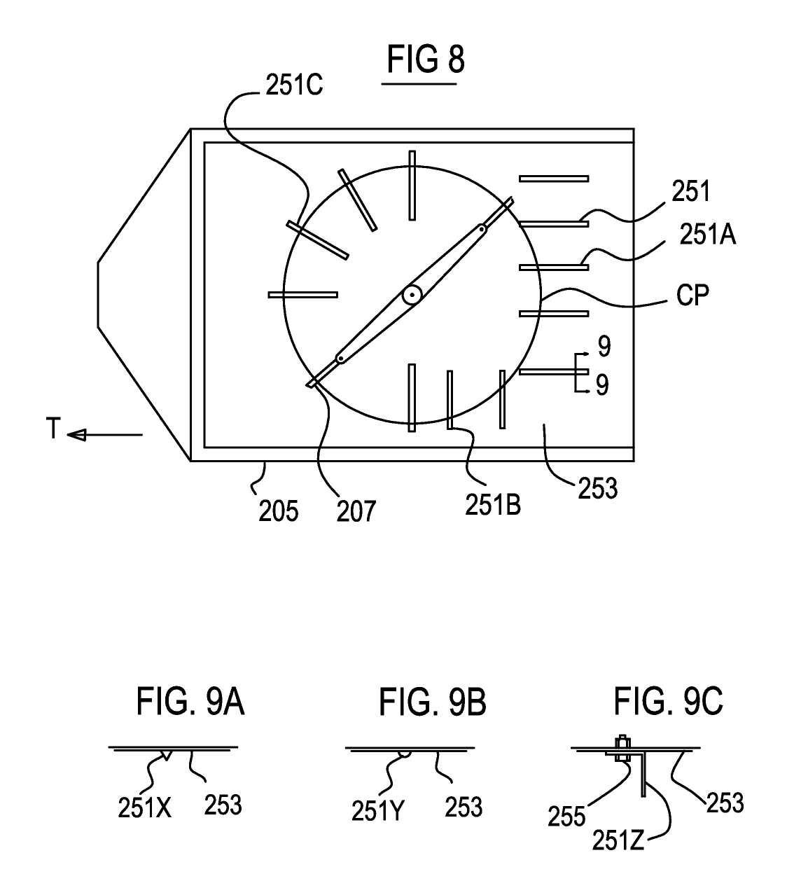

It has been found that retarding the flow of chopped corn stalks under the mower deck retains the stalks under the mower deck for an increased period of time, such that the stalks are contacted by the blades an increased number of times, and so are cut into smaller pieces, increasing the fineness of the cut. FIG. 8 schematically illustrates a bottom view of a mower deck 205 of the present invention comprising a plurality of elongate retarding members 251 mounted below the underside 253 of the mower deck 205. Each retarding member 251 extends transverse to the circular path CP of the blades 207 and transverse to the flow path of chopped corn stalks which is essentially tangential to the circular path CP. The retarding members 251 thus retard the flow of chopped corn stalks.

The retarding members 251 can be positioned in a variety of orientations, as illustrated in FIG. 8, and still achieve the retarding action needed to increase the fineness of cut. Basically the retarding members 251 are oriented transverse to, or generally across, the circular path CP of the blades 207 so that the flow of chopped corn stalks tangential to that path CP is retarded. Retarding members 251A are oriented in alignment with the operating travel direction T, while retarding members 251B are oriented substantially perpendicular to the operating travel direction T. Both retarding members 251A, 251B are positioned so that they are transverse to the circular path CP.

Retarding members 251C are positioned such that they extend substantially radially with respect to the circular path CP, and are substantially equally spaced along the circular path CP. This configuration has the advantage that the degree of retardation of the vegetation flow is substantially equal around the circular path CP.

The retarding members 251 can take a variety of shapes as well and still perform the retarding function. FIG. 9A illustrates a retarding member 251X that has a triangular cross section. FIG. 9B illustrates a retarding member 251Y that has a semicircular cross section. FIG. 9C illustrates a retarding member 251Z that has a rectangular cross section.

While the retarding members 251 can be attached to the underside 253 of the deck 205 by welding or the like, it may also be desirable to make the retarding members 251 removable. For example in FIG. 9C the retarding member 251Z is attached to the underside 253 by a removable bolt 255.

Thus the present invention provides a method and apparatus for lifting corn stalks and like crop residue up off a field surface so same comes into the path of the rotating blades of a rotary mower. Retarding members can be added to keep the stalks under the deck for longer so same are contacted more often by blades and cut into finer pieces.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A method of lifting corn stalks from a field surface and chopping the corn stalks with a rotary mower comprising a rotating blade assembly mounted under a mower deck, the method comprising:
configuring blades of the blade assembly such that as the blade assembly rotates, air is drawn upward under the mower deck;
configuring the rotary mower such that an area of a circle defined by a circular path of outer tips of blades of the blade assembly is greater than 60 square feet; and
rotating the blade assembly such that the outer tips of the blades move at a speed greater than 20,000 feet per minute and such that the air drawn upward under the mower deck draws corn stalks up from the field surface into contact with the blades.

2. The method of claim 1 comprising configuring the blades such that at least a portion of at least one blade slopes upward from a leading edge thereof to a trailing edge thereof.

3. The method of claim 1 wherein the blade assembly comprises a central portion, and wherein the blades are pivotally attached to the central portion about substantially vertical blade pivot axes.

4. The method of claim 1 comprising providing the rotary mower with a blade assembly with a diameter of at least nine feet.

5. The method of claim 4 comprising providing the rotary mower with a blade assembly with a diameter of about ten feet, and rotating the blade assembly at a speed greater than 640 revolutions per minute.

6. The method of claim 4 comprising reducing a start-up torque required to be exerted by a tractor power take off shaft to begin rotation of the blade assembly.

7. The method of claim 6 wherein the start-up torque is reduced by providing at least one centrifugal clutch in a drive line of the rotary mower.

8. The method of claim 6 wherein the blade assembly comprises a central portion rotating about a substantially vertical rotational axis, and wherein the blades are pivotally attached to the central portion about substantially vertical blade pivot axes, and wherein the start-up torque is reduced by exerting a bias force on each blade urging each blade to pivot about the arm axis toward the rotational axis.

9. The method of claim 1 comprising retarding flow of chopped corn stalks under the mower deck by mounting a plurality of elongate retarding members below the underside of the mower deck, each retarding member extending transverse to the circular path of the blades and transverse to a flow path of chopped corn stalks.

10. The method of claim 9 comprising orienting the retarding members such that the retarding members are substantially equally spaced along the circular path and extend substantially radially with respect to the circular path.

11. A rotary mower apparatus for lifting corn stalks from a field surface and chopping the corn stalks, the apparatus comprising:
a rotating blade assembly mounted under a mower deck, wherein blades of the blade assembly are configured such that as the blade assembly rotates, air is drawn upward under the mower deck;
wherein an area of a circle defined by a circular path of outer tips of blades of the blade assembly is greater than 60 square feet; and
wherein the blade assembly rotates at a rotational speed such that the outer tips of the blades move at a speed greater than 20,000 feet per minute and such that the air drawn upward under the mower deck draws corn stalks up from the field surface into contact with the blades.

12. The apparatus of claim 11 wherein at least a portion of at least one blade slopes upward from a leading edge thereof to a trailing edge thereof.

13. The apparatus of claim 11 wherein the blade assembly comprises a central portion, and wherein the blades are pivotally attached to the central portion about substantially vertical blade pivot axes.

14. The apparatus of claim 11 wherein the blade assembly has a diameter of at least nine feet.

15. The apparatus of claim 14 wherein the blade assembly has a diameter of about ten feet, and the blade assembly is rotated at a speed greater than 640 revolutions per minute.

16. The apparatus of claim 14 comprising mechanism operative to reduce a start-up torque required to be exerted by a tractor power take off shaft to begin rotation of the blade assembly.

17. The apparatus of claim 16 wherein the mechanism operative to reduce the start-up torque comprises at least one centrifugal clutch in a drive line of the rotary mower.

18. The apparatus of claim 16 wherein the blade assembly comprises a central portion rotating about a substantially vertical rotational axis, and wherein the blades are pivotally attached to the central portion about substantially vertical blade pivot axes, and wherein the mechanism operative to reduce the start-up torque comprises a bias mechanism operative to exert a bias force on each blade urging each blade to pivot about the arm axis toward the rotational axis.

19. The apparatus of claim 11 comprising a plurality of elongate retarding members mounted below the underside of the mower deck, each retarding member extending transverse to the circular path of the blades and transverse to a flow path of cut vegetation.

20. The apparatus of claim 19 wherein the retarding members are substantially equally spaced along the circular path of the blades and extend substantially radially with respect to the circular path of the blades.

21. A rotary mower apparatus adapted for connection to a power take off shaft of a tractor, the apparatus comprising:
a rotating blade assembly mounted under a mower deck and rotated by a driveline connected to the power take off shaft, the blade assembly having a diameter of at least nine feet; and
a mechanism operative to reduce a start-up torque required to be exerted by the tractor power take off shaft to begin rotation of the blade assembly.

22. The apparatus of claim 21 wherein the mechanism operative to reduce the start-up torque comprises at least one centrifugal clutch in a drive line of the rotary mower.

23. The apparatus of claim 21 wherein the blade assembly comprises a central portion rotating about a substantially vertical rotational axis, and wherein the blades are pivotally attached to the central portion about substantially vertical blade pivot axes, and wherein the mechanism operative to reduce the start-up torque comprises a bias mechanism operative to exert a bias force on each blade urging each blade to pivot about the arm axis toward the rotational axis.
